(19) United States
(12) Patent Application Publication
(10) Pub. No.: US 2015/0289289 A1
(43) Pub. Date: Oct. 8, 2015

(54) METHOD AND APPARATUS FOR SCHEDULING CONTROL

(71) Applicant: OPTIS CELLULAR TECHNOLOGY, LLC, Plano, TX (US)

(72) Inventors: Yu Qian, Beijing (CN); Qianxi Lu, Beijing (CN); Stefan Wänstedt, Lulea (SE); Rui Fan, Beijing (CN)

(21) Appl. No.: 14/431,874

(22) PCT Filed: Sep. 28, 2012
(86) PCT No.: PCT/CN2012/082377

§ 371 Date: Mar. 27, 2015

(51) Int. Cl. H04W 72/14; H04W 72/12; H04L 5/00

(52) U.S. Cl. CPC H04W 72/14; H04L 5/0055; H04W 72/1284; H04W 88/08

(57) ABSTRACT

Methods and apparatuses for scheduling control have been provided, wherein a method for a scheduling request at a user equipment may comprise: starting a timer for delaying triggering of a scheduling request in response to receiving an uplink grant to be requested by the scheduling request before the expiry of the timer, stopping the timer; and cancelling the triggering of the scheduling request upon the stopping of the timer. Thus, by delaying or even cancelling trigger of a scheduling request, the resources consumption of scheduling request transmission may be reduced.

### FIELD OF INVENTION

Embodiments of the present invention generally relate to a technical field of communications, and more particularly to methods and apparatuses for scheduling control.

### BACKGROUND OF INVENTION

This section introduces aspects that may help facilitate a better understanding of the invention(s) and embodiments thereof. Accordingly, the statements of this section are to be read in this light and are not to be understood as admissions about what is in the prior art or what is not in the prior art.

The abbreviations and terms appearing in the description and drawings are defined as below.

3GPP Third Generation Partnership Project

LTE Long Term Evolution

UL uplink

DL downlink

eNB evolved Node-B

BS Base Station

UE User Equipment

SR Scheduling Request

D-SR Dedicated Scheduling Request

RA-SR Random Access Scheduling Request

PUSCH Physical Uplink Shared Channel

PUCCH Physical Uplink Control Channel

PRACH Physical Random Access Channel

RLC Radio Link Control

TCP Transmission Control Protocol

PDU Protocol Data Unit

AM Acknowledge Mode

ACK/NACK Acknowledge/Negative Acknowledge

DRX Discontinuous Reception

DPI Deep Packet Inspection

The 3GPP specification for LTE specifies a procedure of UL transmission, which can be described as the following steps: 1) a SR is triggered by the UE, and is transmitted from a UE to an eNB; 2) an UL grant is sent from the eNB to the UE; and 3) UL data are transmitted on the granted PUSCH resources from the UE to the eNB. By doing so, the eNB can acquire information about data amount in the UL buffer of the UE via SR in order to control the UL transmission.

According to the 3GPP specification, a D-SR and a RA-SR are common modes of SRs. The resources for the D-SR on the PUCCH are dedicated SR resources for a UE, which are typically allocated periodically. In many cases, the usage ratio of allocated D-SR resources on the PUCCH is very low, particularly in the case of a short D-SR period. For example, for Background, Instant Messaging and Web Browsing traffic, the D-SR resources are often underutilized in the case of the D-SR periods of 1 ms, 1 ms, 5 ms, 10 ms and 80 ms.

In order to reduce the resource consumption of the D-SR, the RA-SR is used instead by a UE. The resource for one RA-SR is shared among a plurality of RA-SRs which may be triggered by different UEs, but not dedicated to one UE. From this perspective, the usage of RA-SR alleviates the problem of the resource waste of the D-SR. However, in the RA-SR mode, PUSCH resources for UL data are requested through the random access procedure on PRACH. The random access procedure may introduce other overheads than the overheads related to SR, and therefore may consume a lot of system resources.

### SUMMARY OF INVENTION

Therefore, it would be desirable in the art to provide solutions for reducing SR resource consumption.

In a first aspect, embodiments of the present invention provide a method for a scheduling request at a UE. The method may comprise: starting a timer for delaying triggering of a SR; in response to receiving an uplink grant to be requested by the SR before the expiry of the timer, stopping the timer; and cancelling the triggering of the SR upon the stopping of the timer.

In an embodiment, the method may further comprise triggering the SR upon the expiry of the timer.

In an embodiment, the method may comprise determining that uplink transmission to be performed is a feedback required for downlink transmission.

In an embodiment, the feedback is ACK/NACK for a downlink RLC PDU or a downlink TCP PDU.

In an embodiment, the method may comprise receiving information on the length of the timer from a base station.

In a second aspect, embodiments of the present invention provide a method for scheduling at a base station. The method may comprise: determining a length of a timer for delaying triggering of a SR of a UE; and transmitting information on the determined length of the time to the UE.

In an embodiment, the method may comprise determining that the downlink transmission requires a feedback; and based on the length of the timer, transmitting an uplink grant.

In an embodiment, the downlink transmission is a RLC PDU or a TCP PDU.

In an embodiment, the method may comprise based on at least one of a SR period, a DRX cycle, and a traffic delay requirement, determining the length of the timer.

In a third aspect, embodiments of the present invention provide a method for scheduling at a base station. The method may comprise: predicting uplink transmission based on downlink transmission requiring a feedback required; and transmitting an uplink grant for the predicted uplink transmission to a UE.

In an embodiment, the method may further comprise determining that a RLC PDU is transmitted on the downlink; and based on a poll bit included in the transmitted RLC PDU, predicting ACK/NACK to be transmitted on the uplink.

In an embodiment, the method may comprise determining that a TCP PDU is transmitted on the downlink; and predicting ACK/NACK to be transmitted on the uplink.

In an embodiment, the method may further comprise using DPI to determine that a TCP PDU is transmitted on the downlink.

In an embodiment, the method may further comprise based on a mark stamped in a header of a downlink data packet, determining that a TCP PDU is transmitted on the downlink.

In an embodiment, the method may comprise determining a length of a timer for delaying triggering of a SR of the UE; and transmitting the uplink grant based on the length of the timer.

In a fourth aspect, embodiments of the present invention provide an apparatus for a scheduling request at a UE. The apparatus may comprise: a timer starting module, configured to start a timer for delaying triggering of a SR; a timer stopping module, configured to stop the timer in response to receiving an uplink grant to be requested by the SR before the expiry of the timer; and a triggering cancelling module, configured to cancel the triggering of the SR upon the stopping of the timer.

In an embodiment, the apparatus further comprises a triggering module configured to trigger the SR upon the expiry of the timer.

In an embodiment, the apparatus further comprises a transmission determining module configured to determine that uplink transmission to be performed is a feedback required for downlink transmission.

In an embodiment, the apparatus further comprises a receiving module configured to receive the length of the timer from a base station.

In a fifth aspect, embodiments of the present invention provide an apparatus for scheduling at a base station. The apparatus may comprise: a timer length determining module, configured to determine a length of a timer for delaying triggering of a SR of a UE; and a transmitting module, configured to transmit information on the determined length of the timer to the UE.

In an embodiment, the apparatus further comprises a transmission determining module configured to determine that downlink transmission requires a feedback. The transmitting module is further configured to transmit an uplink grant to the user equipment based on the length of the timer

In a sixth aspect, embodiments of the present invention provide an apparatus for scheduling at a base station. The apparatus may comprise: a predicting module, configured to predict uplink transmission based downlink transmission requiring a feedback; and a transmitting module, configured to transmit an uplink grant for the predicted uplink transmission to a UE.

Embodiments of the present invention provide an improved SR triggering mechanism, wherein triggering of SR is cancelled in some cases. Accordingly, a part of PUSCH resources for SR are saved in the UL transmission procedure.

Other features and advantages of the embodiments of the present invention will also be understood from the following description of specific embodiments when read in conjunction with the accompanying drawings, which illustrate, by way of example, the principles of embodiments of the present invention.

### BRIEF DESCRIPTION OF DRAWINGS

The above and other aspects, features and benefits of various embodiments of the invention will become more apparent, by way of example, from the following detailed description and the accompanying drawings, in which:

FIG. 1 illustrates an exemplary flowchart of a method 100 for a scheduling request according to an embodiment of the present invention;

FIG. 2 illustrates an exemplary flowchart of a method 200 for a scheduling request according to another embodiment of the present invention;

FIG. 3 illustrates an exemplary flowchart of a method 300 for scheduling according to an embodiment of the present invention;

FIG. 4 illustrates an exemplary flowchart of a method 400 for scheduling according to another embodiment of the present invention;

FIG. 5 illustrates an exemplary flowchart of a method 500 for scheduling according to an embodiment of the present invention;

FIG. 6 illustrates an exemplary flowchart of a method 600 for scheduling according to another embodiment of the present invention;

FIG. 7 is a schematic block diagram of an apparatus 700 for a scheduling request that may be configured to implement exemplary methods according to an embodiment of the present invention;

FIG. 8 is a schematic block diagram of an apparatus 800 for scheduling that may be configured to implement exemplary methods according to an embodiment of the present invention; and

FIG. 9 is a schematic block diagram of an apparatus 900 for scheduling that may be configured to implement exemplary methods according to an embodiment of the present invention.

Like reference numbers and designations in the various drawings indicate like elements.

### DETAILED DESCRIPTION OF EMBODIMENTS

Hereinafter, the principle and spirit of the present invention will be described with reference to the illustrative embodiments. It should be understood, all these embodiments are given merely for the skilled in the art to better understand and further practice the present invention, but not for limiting the scope of the present invention. For example, features illustrated or described as part of one embodiment may be used with another embodiment to yield still a further embodiment. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the description with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

In the following description, the proposed mechanism will be described in detail with respect to exemplary embodiments illustrated in the drawings.

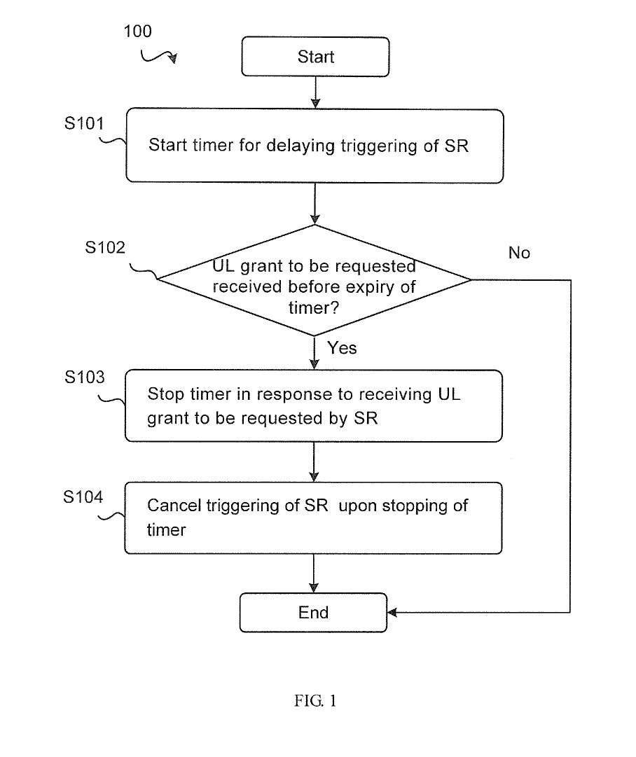

FIG. 1 illustrates an exemplary flowchart of a method 100 for a scheduling request according to an embodiment of the present invention. In embodiments of the present invention, method 100 may be performed, for example, at a UE. Those skilled in the art could understand that, the method 100 may be performed by an entity in the UE.

As shown in FIG. 1, after the method 100 starts, at step S101, a timer is started for delaying triggering of a SR. According to the 3GPP specification, when a UE has data to be transmitted on the UL, it may first obtain from a base station (e.g. an eNB) an UL grant which indicates the resources allocated for the UL data. Generally, a SR is sent from a UE to an eNB so as to request a UL grant. In embodiments of the present invention, when the UE has UL data to be transmitted and wants to trigger a SR for requesting an UL grant, it may start a timer for delaying the triggering of the SR. In this case, the UE may not trigger the SR while the timer is running.

Then, the method 100 proceeds to step S102, where it is determined that whether an UL grant to be requested by the SR is received before the expiry of the timer. As an example, the resources for the UL data are allocated through the UL grant, and accordingly there is no need for the UE to trigger the SR. According to embodiments of the present invention, at step S103, if the UL grant is received before the expiry of the timer, the timer is stopped in response. Next, at step S104, the triggering of the SR is cancelled upon the stopping of the timer.

By delaying trigger of a SR, and even cancelling triggering of a SR in response to receiving the UL grant corresponding to the SR, the resources for SR transmission may be reduced to some extent.

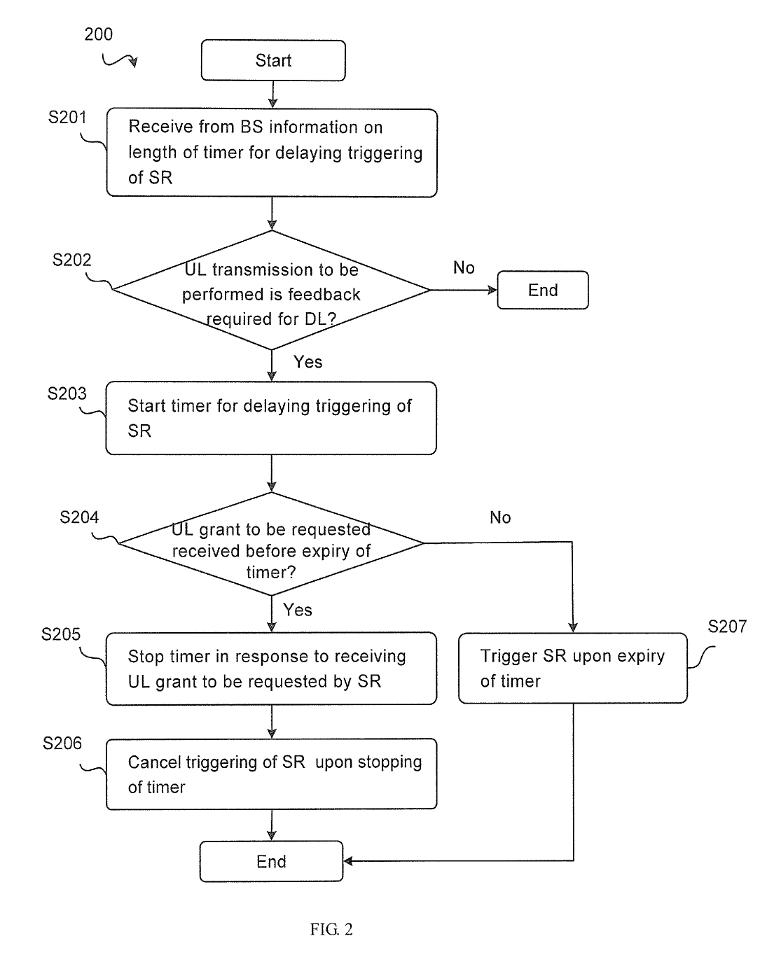

Now referring to FIG. 2, a method 200 for a scheduling request according to another embodiment of the present invention is illustrated. Method 200 may be considered as another embodiment of method 100 described above with reference to FIG. 1. In embodiments of the present invention, method 200 may also be performed, for example, at a UE or an entity in the UE.

After the method 200 starts, at step S201, information on the length of the timer for delaying triggering of a SR is received from a BS (e.g. an eNB). In embodiments of the present invention, the length of the timer may be set by the eNB. Moreover, the information may not be received every time there is UL data to be transmitted. As an example, the information may be received when the UE originally has access to the eNB. Alternatively, in the case that the UE is in a connected mode, the information may be sent from the eNB to the UE whenever the eNB resets the length. In an embodiment of the present invention, after receiving the information on the length of the timer, the UE may store it locally, e.g. in a local memory. In this way, the UE may obtain the length from the local memory when it needs it.

Next, the method 200 proceeds to step 5202, where it is determined whether UL transmission to be performed is a feedback required for DL transmission. If it is, the timer for delaying the trigger of the SR is started at step S203.

According to the 3GPP specification, some DL data require a feedback, such as ACK/NACK, in terms of protocol stacks of a UE and an eNB. For example, in the RLC layer, DL transmission in RLC AM mode requires ACK/NACK as a feedback. Additionally, DL transmission in the TCP layer also requires ACK/NACK as a feedback. In this case, when the eNB transmits DL data requiring a feedback, such as RLC PDUs in AM or TCP PDUs, it may know that there would be ACK/NACK on the UL, and automatically allocate the resources for such UL transmission without waiting for the corresponding SR. Accordingly, the UE may not be needed to trigger a SR for requesting the UL grant. As a result, in embodiments of the present invention, considering the automatic allocation of an UL grant as described above, the UE may delay the triggering of the SR if the UL transmission is a feedback required for the DL transmission.

Steps S203-S206 in the method 200 respectively correspond to steps S101-S104 in the method 100. The specific implementation of steps S203-S206 may refer to the embodiments of steps S101-S104 as illustrated in FIG. 1, which will no longer be detailed here.

In the method 200, if no UL grant to be requested by the SR is received before the timer expires, the process proceeds to step S207, where the SR is triggered upon the expiry of the timer. As a result, the UE may timely obtain UL resources as it requires.

It is noted that the method 200 shown in FIG. 2 and described above is only for the purpose of illustrating principles of the present invention, rather than limiting the scope thereof. In fact, the method 200 is just another embodiment of the method 100 shown in FIG. 1, and those skilled in the art will readily envisage other possible embodiments.

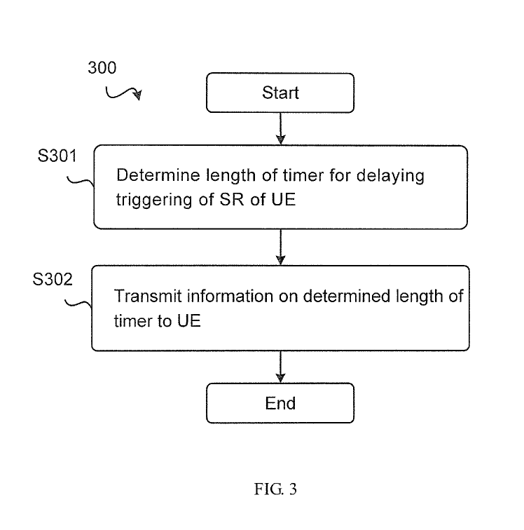

FIG. 3 illustrates an exemplary flowchart of a method 300 for scheduling according to an embodiment of the present invention. In embodiments of the present invention, the method 300 may be performed at a BS (e.g., an eNB) or equivalent thereof. Those skilled in the art would understand that the method 300 may be performed at an entity in the BS or equivalent thereof.

As shown in FIG. 3, after the method 300 starts, the length of the timer for delaying triggering of a SR of a UE is determined at step S301. Then, information on the determined length of the timer is transmitted to the UE. As mentioned above, the transmission may be performed when the UE originally has access to the eNB or when the length is reset. In this way, the UE may use the timer to delay triggering of a SR, and therefore the resources for SR transmission are reduced. This process will now be explained in more detail.

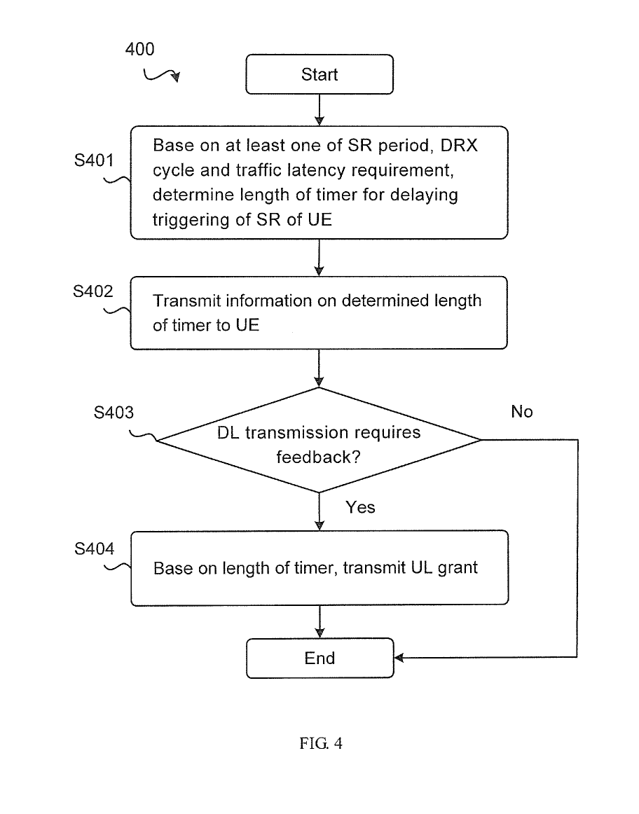

Referring to FIG. 4, a method 400 for scheduling according to another embodiment of the present invention is illustrated. Similarly, the method 400 may be considered as an embodiment of method 300 described above with reference to FIG. 3. In embodiments of the present invention, the method 400 may also be performed, for example, at a base station or equivalent thereof, or at an entity in the base station or equivalent thereof.

After the method 400 starts, at step S401, the length of the timer for delaying the triggering of the SR of the UE is determined based on at least one of a SR period, a DRX cycle, and a traffic latency requirement. In embodiments of the present invention, the timer length is set at the base station, e.g. eNB.

According to embodiments of the present invention, the UE may receive an UL grant while the delay timer is running. Accordingly, in an embodiment of the present invention, the setting of the delay timer length may take into account a SR period, a DRX cycle or a traffic latency requirement. For example, if the D-SR/RA-SR period is 10 ms, the UE would typically wait 10 ms for an opportunity of SR transmission. In this case, if the timer length is less than 10 ms, it may be possible that the UE will not receive an UL grant before the timer expires. Additionally, if the DRX cycle is set as 20 ms, the UE would wake to monitor downlink control information every 20 ms. In this example, no resource scheduling grant from the network side may be expected during the sleep of the UE. Thus, the SR delay timer may be set to be larger than 20 ms; otherwise the UE may probably not be able to receive the UL grant while the timer is running. Further, if the maximum latency requirement of traffic is, for example, 30 ms, the delay timer length of more than 30 ms will not be acceptable. Consequently, considering all of the above factors, a SR delay timer length in the range of 20 to 30 ms would be appropriate. As an example, all of these factors may be specific to a UE and a type of traffic, and different values of the delay timer length should be configured for different UEs and traffic types in practice.

Then, the method 400 proceeds to the step S402, where the information on the determined length of the timer is transmitted to the UE. Similarly, the specific implementation of step S402 may refer to the embodiments of step S302 as illustrated in FIG. 3, which will no longer be detailed here.

Next, the method 400 proceeds to step S403, where it is determined whether DL transmission requires a UL feedback. If it does, at the step S404, an UL grant is transmitted based on the length of the timer.

As mentioned above, the transmission of a RLC PDU in AM or a TCP PDU may require ACK/NACK as a feedback. In an embodiment of the present invention, if the DL data is the data requiring a feedback, such as a RLC PDU in AM and a TCP PDU, it would be determined that there is a need of UL transmission. Accordingly, an UL grant may be transmitted in the case that no SR is triggered.

As mentioned above, the eNB may transmit the information on the timer length to the UE, and therefore the UE may use the timer to delay its SR triggering. In an embodiment of the present invention, in order to timely provide a required UL grant to the UE, the eNB needs to transmit an UL grant during the running of the UE's delay timer. In one embodiment, the eNB may transmit the UL grant during the time period from the time when the UE expectedly responses to the DL data to the time when the delay timer expires. As an example, the eNB may predict when the UE will response to the DL data based on the time that the DL data is transmitted and the UE processing delay. The specific operation of the eNB for determining when to transmit the UL grant to the UE according to embodiments of the present invention will be described below.

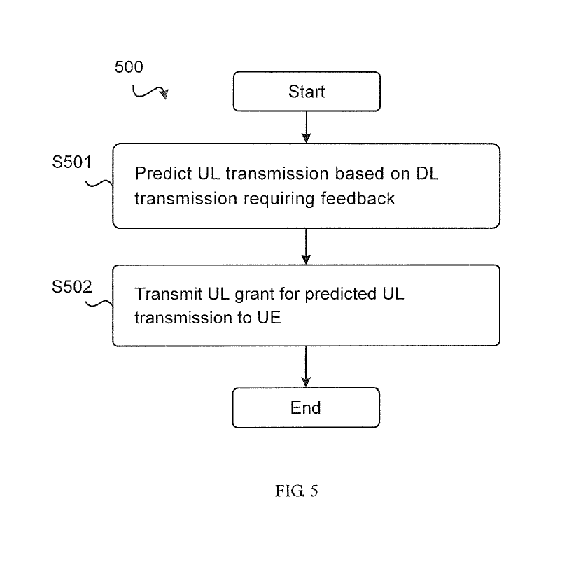

FIG. 5 illustrates an exemplary flowchart of a method 500 for scheduling according to an embodiment of the present invention. In embodiments of the present invention, the method 500 is performed by a BS, e.g. eNB, or equivalent thereof, or by an entity in a BS or equivalent thereof.

As shown in FIG. 5, after the method 500 starts, at step S501, UL transmission is predicted based on DL transmission requiring a feedback. As mentioned above, the transmission of a RLC PDU in AM or a TCP PDU may require ACK/NACK as a feedback. In an embodiment of the present invention, UL data may be predicted based on a RLC PDU in AM or a TCP PDU transmitted on the DL.

Then, at step S502, an UL grant for predicted UL transmission to UE is transmitted. According to embodiments of the present invention, when the eNB predicts that the UE will transmit UL data after the DL data, the eNB may automatically allocate UL resources to the UE instead of waiting for a SR from the UE. This process will now be explained in more detail.

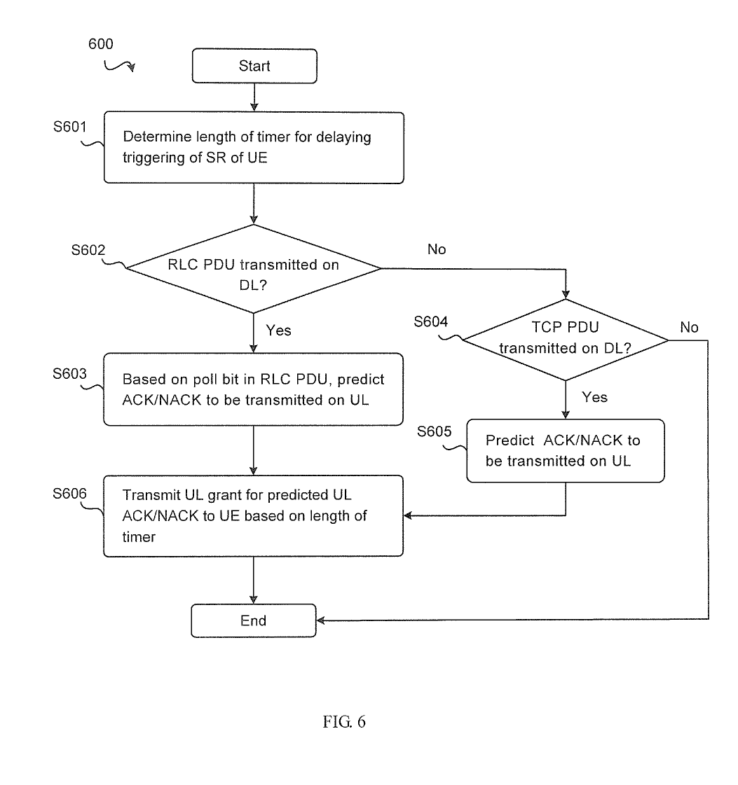

Referring to FIG. 6, an exemplary flowchart of a method 600 for scheduling according to another embodiment of the present invention is illustrated. The method 600 may be considered as an embodiment of method 500 described above with reference to FIG. 5. In embodiments of the present invention, the method 600 may also be performed, for example, at a base station and equivalent thereof, or at an entity in the base station and equivalent thereof.

As shown in FIG. 6, after the method 600 starts, at step S601, the length of the timer for delaying the triggering of the SR of UE is determined. The specific implementation of this step may refer to the embodiments of the corresponding steps of the methods 300 and 400 as illustrated in FIGS. 3 and 4, which will no longer be described in detail here. As mentioned above, those skilled in the art would understand that the timer length determination in the step S601 may not be performed every time DL or UL data is transmitted.

Next, the method 600 proceeds to step S602, where it is determined whether a RLC PDU is transmitted on the DL. If it is, based on a poll bit in RLC PDU, it is predicted that ACK/NACK will be transmitted on the UL at step S603. Here, the poll bit indicates whether the current operation mode is RLC AM. For example, the poll bit may be set to “0” or “1”, wherein the value “0” may indicates RLC AM requiring a feedback, and vice versa.

If the transmitted data is not a RLC PDU, the method 600 proceeds to step S604, where it is determined that whether a TCP PDU is transmitted on the DL. If so, it is further predicted that ACK/NACK will be transmitted on the UL. In embodiments of the present invention, the DPI technique may be used to detect the TCP PDU. In an example, the determination of TCP PDUs may be performed by the eNB. In this example, because the current protocol stacks of the eNB may not include the TCP layer, the function of the eNB may be expanded to perform the determination of TCP PDUs. For example, the hardware of eNB may be expanded to support the DPI in order to detect TCP PDUs. Considering that the TCP layer may not be supported by current eNBs, in another example, the determination of TCP PDU may be performed by the devices of core networks, such as a packet gateway (P-GW) or a serving gateway (S-GW). After the TCP PDU is detected at the core networks by using the DPI, a lower layer protocol header of the DL data packet may be stamped by a “mark” so that the eNB may identify that the data is a TCP PDU. In embodiments of the present invention, the order of determining the RLC PDU and the TCP PDU is not limited to the order as illustrated in FIG. 6. Alternatively, the determination of the RLC PDU may be performed later than the determination of the TCP PDU.

If it is determined that the DL data is a RLC PDU or a TCP PDU requiring ACK/NACK, the method 600 proceeds to step S606, where the UL grant for the predicted UL ACK/NACK is transmitted to the UE based on the length of the timer, The specific implementation may refer to the embodiments described above referring to the method 400 as illustrated in FIG. 4.

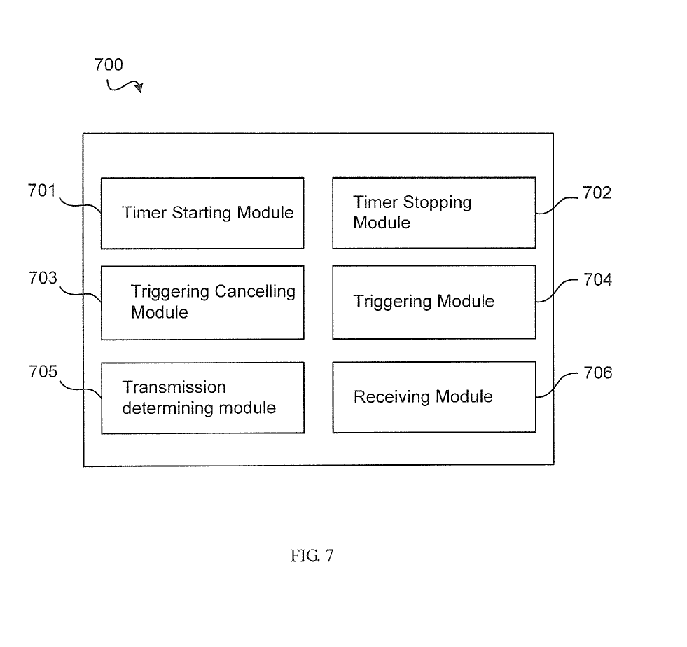

FIG. 7 is a schematic block diagram of an apparatus 700 that may be configured to implement exemplary methods according to an embodiment of the present invention.

As shown in FIG. 7, the apparatus 700 may comprise a timer starting module 701, a timer stopping module 702 and a triggering cancelling module 703. The apparatus 700 may be a UE or an entity in a UE.

In embodiments of the present invention, the timer starting module 701 is configured to start a timer for delaying triggering of a SR; the timer stopping module 702 is configured to stop the timer in response to receiving an uplink grant to be requested by the SR before the expiry of the timer; and the triggering cancelling module 703 is configured to cancel the triggering of the SR upon the stopping of the timer.

As shown in FIG. 7, the apparatus further comprises a triggering module 704, a transmission determining module 705 and a receiving module 706. In embodiments of the present invention, the triggering module 704 is configured to trigger the SR upon the expiry of the timer; the transmission determining module 705 is configured to determine that uplink transmission to be performed is a feedback required for downlink transmission; and the receiving module 706 is configured to receive the length of the timer from a base station.

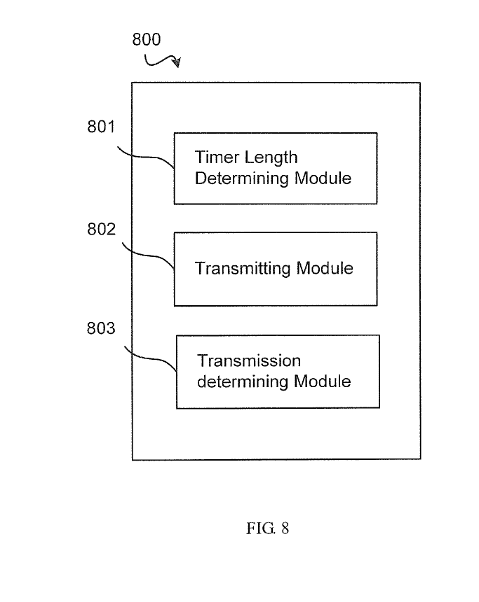

FIG. 8 is a schematic block diagram of an apparatus 800 for scheduling that may be configured to implement exemplary methods according to an embodiment of the present invention.

As shown in FIG. 8, the apparatus 800 may comprise a timer length determining module 801 and a transmitting module 802. The apparatus 800 may be a base station and equivalent thereof or an entity in a base station or equivalent thereof.

In embodiments of the present invention, the timer length determining module 801 is configured to determine a length of a timer for delaying triggering of a SR of a UE; and the transmitting module 802 is configured to transmit information on the determined length of the timer to the UE.

As shown in FIG. 8, the apparatus further comprises a transmission determining module 803. In an embodiment of the present invention, the transmission determining module 803 is configured to determine that downlink transmission requires a feedback. In an embodiment of the present invention, the transmitting module 802 is further configured to transmit an uplink grant to the UE based on the length of the timer.

In an embodiment of the present invention, the timer length determining module 801 is further configured to determine the length of the timer based on at least one of a SR period, a DRX cycle and a traffic latency requirement.

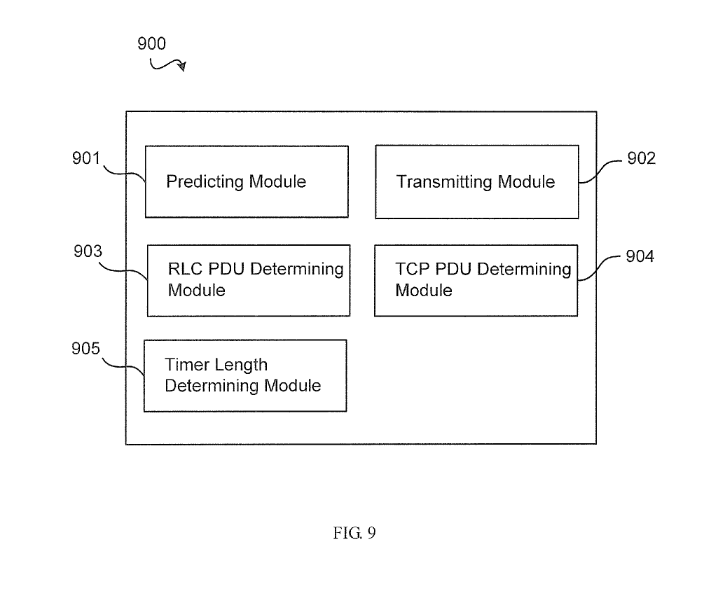

FIG. 9 is a schematic block diagram of an apparatus 900 for scheduling that may be configured to implement exemplary methods according to an embodiment of the present invention.

As shown in FIG. 9, the apparatus 900 may comprise a predicting module 901 and a transmitting module 902. The apparatus 900 may be a base station and equivalent thereof or an entity in a base station or equivalent thereof.

In embodiments of the present invention, the predicting module 901 is configured to predict uplink transmission based on downlink transmission requiring a feedback; and the transmitting module 902 is configured to transmit an uplink grant for the predicted uplink transmission to a user equipment.

As shown in FIG. 9, the apparatus 900 further comprises a RLC PDU determining module 903 and a TCP PDU determining module 904.

In an embodiment of the present invention, the RLC PDU determining module 903 is configured to determine that a RLC PDU is transmitted on the DL; and the predicting module 901 is further configured to predict, based on a poll bit included in the transmitted RLC PDU, that ACK/NACK will be transmitted on the UL.

In an embodiment of the present invention, the TCP PDU determining module 904 is configured to determine that a TCP PDU is transmitted on the DL; and the predicting module 901 is further configured to predict that ACK/NACK will be transmitted on the UL. Particularly, in one example, the TCP PDU determining module 904 is configured to use DPI to determine that a TCP PDU is transmitted on the DL. In another example, the TCP PDU determining module 904 is configured to determine, based on a mark stamped in a header of a downlink data packet, that a TCP PDU is transmitted on the DL.

As shown in FIG. 9, the apparatus 900 further comprises a timer length determining module 905 configured to determine a length of a timer for delaying triggering of a SR of the UE. In an embodiment of the present invention, the timer length determining module 905 is further configured to determine the length of the timer based on at least one of a SR period, a DRX cycle, and a traffic latency requirement. In one embodiment of the present invention, the transmitting module 902 is further configured to transmit the uplink grant based on the length of the timer.

It is noted that the modules of the apparatuses 700 to 900 may be configured to implement respective functionalities as described with reference to FIGS. 1 to 6. Therefore, the features discussed with respect to methods 100 to 600 may apply to the corresponding modules of the apparatuses 400 and 500. It is further noted that the units of the apparatuses 700 to 900 may be embodied in hardware, software, firmware, or any combination thereof.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flowcharts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The various blocks shown in FIGS. 1 to 6 may be viewed as method steps, and/or as operations that result from operation of computer program code, and/or as a plurality of coupled logic circuit elements constructed to carry out the associated function(s). At least some aspects of the exemplary embodiments of the inventions may be practiced in various components such as integrated circuit chips and modules, and that the exemplary embodiments of this invention may be realized in an apparatus that is embodied as an integrated circuit, FPGA or ASIC that is configurable to operate in accordance with the exemplary embodiments of the present invention.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Various modifications, adaptations to the foregoing exemplary embodiments of this invention may become apparent to those skilled in the relevant arts in view of the foregoing description, when read in conjunction with the accompanying drawings. Any and all modifications will still fall within the scope of the non-limiting and exemplary embodiments of this invention. Furthermore, other embodiments of the inventions set forth herein will come to mind to one skilled in the art to which these embodiments of the invention pertain having the benefit of the teachings presented in the foregoing descriptions and the associated drawings.

Therefore, it is to be understood that the embodiments of the invention are not to be limited to the specific embodiments disclosed and that modifications and other embodiments are intended to be included within the scope of the appended claims. Use of the verb “comprise” and its conjugations does not exclude the presence of elements or steps other than those stated in a claim. The indefinite article “a” or “an” preceding an element or step does not exclude the presence of a plurality of such elements or steps. Although specific terms are used herein, they are used in a generic and descriptive sense only and not for purposes of limitation.

1. A method for a scheduling request at a user equipment, comprising:
starting a timer for delaying triggering of a scheduling request;
in response to receiving an uplink grant to be requested by the scheduling request before the expiry of the timer, stopping the timer; and
cancelling the triggering of the scheduling request upon the stopping of the timer.

2. The method of claim 1, comprising:
triggering the scheduling request upon the expiry of the timer.

3. The method of claim 1, comprising:
determining that uplink transmission to be performed is a feedback required for downlink transmission.

4. The method of claim 3, wherein the feedback is acknowledgement, ACK, or negative acknowledgement, NACK, for a downlink radio link control, RLC, protocol data unit, PDU, or a downlink transmission control protocol, TCP, PDU.

5. The method of claim 1, comprising:
receiving information on the length of the timer from a base station.

6. A method for scheduling at a base station, comprising:
determining a length of a timer for delaying triggering of a scheduling request of a user equipment; and
transmitting information on the determined length of the timer to the user equipment.

7. The method of claim 6, comprising:
determining that downlink transmission requires a feedback; and
based on the length of the timer, transmitting an uplink grant.

8. The method of claim 7, wherein the downlink transmission is a radio link control, RLC, protocol data unit, PDU, or a transmission control protocol, TCP, PDU.

9. The method of claim 6, further comprising:
based on at least one of a scheduling request period, a discontinuous reception cycle, and a traffic latency requirement, determining the length of the timer.

10. A method for scheduling at a base station, comprising:
predicting uplink transmission based on downlink transmission requiring a feedback; and
transmitting an uplink grant for the predicted uplink transmission to a user equipment.

11. The method of claim 10, further comprising:
determining that a radio link control, RLC, protocol data unit, PDU, is transmitted on the downlink; and
based on a poll bit included in the transmitted RLC PDU, predicting acknowledgement, ACK, or negative acknowledgement, NACK, to be transmitted on the uplink.

12. The method of claim 10, further comprising:
determining that a transmission control protocol, TCP, Protocol Data Unit, PDU, is transmitted on the downlink; and
predicting acknowledgement, ACK, or negative acknowledgement, NACK, to be transmitted on the uplink.

13. The method of claim 12, further comprising:
using deep packet inspection to determine that a TCP PDU IS transmitted on the downlink.

14. The method of claim 12, further comprising:
based on a mark stamped in a header of a downlink data packet, determining that a TCP PDU is transmitted on the downlink.

15. The method of claim 10, comprising:
determining a length of a timer for delaying triggering of a scheduling request of the user equipment; and
transmitting the uplink grant based on the length of the timer.

16. The method of claim 15, further comprising:
based on at least one of a scheduling request period, a discontinuous reception cycle, and
a traffic latency requirement, determining the length of the timer.

17. An apparatus for a scheduling request at a user equipment, comprising:
a timer starting module, configured to start a timer for delaying triggering of a scheduling request;
a timer stopping module, configured to stop the timer in response to receiving an uplink grant to be requested by the scheduling request before the expiry of the timer; and
a triggering cancelling module, configured to cancel the triggering of the scheduling request upon the stopping of the timer.

18. The apparatus of claim 17, comprising:
a triggering module, configured to trigger the scheduling request upon the expiry of the timer.

19. The apparatus of claim 17, comprising:
a transmission determining module, configured to determine that uplink transmission to be performed is a feedback required for downlink transmission.

20. The apparatus of claim 17, comprising:
a receiving module, configured to receive the length of the timer from a base station.

21.-30. (canceled)
